(19) United States
(12) Patent Application Publication
(10) Pub. No.: US 2023/0003752 A1
(43) Pub. Date: Jan. 5, 2023

(54) FLUID HANDLING USING RECEPTACLE MARKING FOR NEEDLE POSITIONING

(71) Applicant: Agilent Technologies, Inc., Santa Clara, CA (US)

(72) Inventor: Hans-Peter Zimmermann, Waldbronn (DE)

(21) Appl. No.: 17/780,485

(22) PCT Filed: Dec. 1, 2020
(86) PCT No.: PCT/IB2020/061303

§ 371 Date: May 26, 2022

(30) Foreign Application Priority Data
Dec. 2, 2019 (GB) 1917574.4

(51) Int. Cl. G01N 35/00; G01N 35/10

(52) U.S. Cl. CPC G01N 35/00732; G01N 35/1011; G01N 2035/00752; G01N 2035/00851; G01N 2035/0494

(57) ABSTRACT

A fluid handling unit is configured for handling a fluid contained or to be contained in a receptacle bearing a marking. The unit includes a needle having an elongated shape with an open end and for aspirating the fluid from the receptacle and/or dispensing the fluid into the receptacle. The fluid handling unit further includes a needle drive for positioning the needle with respect to the receptacle, a detection unit for detecting the marking of the receptacle, and a control unit. The control unit is configured for analyzing the detected marking for determining at least one feature that is part of the marking or the marking itself, determining a target position based on the detected at least one feature, and operating the needle drive to position the open end of the needle relative to the determined target position.

### BACKGROUND ART

The present invention relates to fluid handling in particular for chromatographic sample separation.

For liquid separation in a chromatography system, a mobile phase comprising a sample fluid (e.g. a chemical or biological mixture) with compounds to be separated is driven through a stationary phase (such as a chromatographic column packing), thus separating different compounds of the sample fluid which may then be identified. The term compound, as used herein, shall cover compounds which might comprise one or more different components.

The mobile phase, for example a solvent, is pumped under high-pressure typically through a chromatographic column containing packing medium (also referred to as packing material or stationary phase). As the sample is carried through the column by the liquid flow, the different compounds, each one having a different affinity to the packing medium, move through the column at different speeds. Those compounds having greater affinity for the stationary phase move more slowly through the column than those having less affinity, and this speed differential results in the compounds being separated from one another as they pass through the column. The stationary phase is subject to a mechanical force generated in particular by a hydraulic pump that pumps the mobile phase usually from an upstream connection of the column to a downstream connection of the column. As a result of flow, depending on the physical properties of the stationary phase and the mobile phase, a relatively high-pressure drop is generated across the column.

The mobile phase with the separated compounds exits the column and passes through a detector, which registers and/or identifies the molecules, for example by spectrophotometric absorbance measurements. A two-dimensional plot of the detector measurements against elution time or volume, known as a chromatogram, may be made, and from the chromatogram the compounds may be identified. For each compound, the chromatogram displays a separate curve feature also designated as a “peak”.

In preparative chromatography systems, a liquid as the mobile phase is provided usually at a controlled flow rate (e. g. in the range of 1 mL/min to thousands of mL/min, e.g. in analytical scale preparative LC in the range of 1-5 mL/min and preparative scale in the range of 4-200 mL/min) and at pressure in the range of tens to hundreds bar, e.g. 20-600 bar.

In high performance liquid chromatography (HPLC), a liquid as the mobile phase has to be provided usually at a very controlled flow rate (e. g. in the range of microliters to milliliters per minute) and at high-pressure (typically 20-100 MPa, 200-1000 bar, and beyond up to currently 200 MPa, 2000 bar) at which compressibility of the liquid becomes noticeable.

The sample fluid to be separated is typically provided in a respective receptacle, such as a vial, and needs to be transferred from such respectable to an injection unit configured for injecting the sample fluid into the mobile phase. This is typically done by a fluid handling unit providing a more or less automated handling of one or more receptacles, each containing a respective sample fluid. Such fluid handling—prior to sample injection—may comprise transport of the receptacle, e.g. from and to a vial tray, operating an injection needle to immerse into the respective receptacle and aspirate sample fluid therefrom, and transporting the aspirated sample fluid, e.g. to a dedicated injection valve, for injection into the mobile phase. Additionally or alternatively, separated fractions of the sample fluid may be dispensed into a respective receptacle, which may also comprise transport of the receptacle, operating an injection needle to immerse into the respective receptacle and dispense an amount of the separated fractions into the receptacle.

WO2019207844A1 discloses an autosampler with an imaging unit providing image recognition used for operating an injection needle to a sample containing vial.

While optical recognition of vials can provide acceptable results under controlled conditions, it has been shown that limitations can occur under real life situations, e.g. as resulting from varying light conditions, reflecting surfaces, stray light, dirt, or others, rendering optical recognition failure prone.

### DISCLOSURE

It is an object of the invention to provide an improved fluid handling, preferably for chromatographic sample separation. The object is solved by the independent claims. Further embodiments are shown by the dependent claims.

In a preferred embodiment comprises a fluid handling unit configured for handling a fluid contained or to be contained in a receptacle bearing a marking. The receptacle has a body for containing the fluid and an opening for reaching into the receptacle, and the marking is positioned on the receptacle in a spatially defined relationship to the opening into the receptacle. The fluid handling unit comprises a needle having an elongated shape with an open end (such as a needle tip) and being configured for at least one of: aspirating (also referred to as intaking) the fluid from the receptacle and dispensing (also referred to as outputting or discharging) the fluid into the receptacle. The fluid handling unit further comprises a needle drive configured for (spatially) positioning the needle with respect to the receptacle, a detection unit configured for detecting at least the marking of the receptacle, and a control unit. The control unit is configured for at least analysing the detected marking for determining (e.g. detecting, calculating, recognizing, or similar) at least one feature being part of the marking or the marking itself, determining a target position based on the detected at least one feature, wherein the target position is selected to be in spatial relationship to the center point of the opening, and operating the needle drive to (spatially) position the open end of the needle relative to the determined target position. This allows to provide a more reliable fluid handling under real life situations, e.g. as resulting from varying light conditions, reflecting surfaces, stray light, dirt, or others. Further, the likelihood for not precisely detecting the (preferably purpose-made) marking might be lower than not precisely detecting the surface of the receptacle e.g. with the optical background of the receptacle holding unit, especially if receptacles of different material and/or color are used.

In one embodiment, the control unit is configured for correcting a deviation of an actual position from the determined target position of the open end of the needle, preferably by determining the deviation by using at least one of: an image recognition, an optical measurement, a capacitive measurement, and an inductive measurement. Without correcting the deviation, the open end of the needle would not hit the determined target position when being moved toward the target position. Preferably, the control unit is configured for operating the needle drive to correct for the determined deviation, so that after correction of the deviation, the open end of the needle would hit the determined target position when being moved toward the target position.

In one embodiment, a reference position for providing a correction of the deviation of the actual position from the determined target position is provided by a coordinate system, e.g. of the needle drive. For example, the actual position of the needle, preferably a needle tip, can be determined with respect to such coordinate system. This may result e.g. from analysing the control information applied by the needle drive to position the needle. In other words, the operation information used for moving the needle by the needle drive can be applied for determining the actual position of the needle (or the needle tip), which may be set in relation to the coordinate system, e.g. to a defined starting point of the needle (or needle tip). Such starting point may be, for example, a defined spatial position of the needle (or needle tip) within the fluid handling unit, such as when the needle is positioned in a fluid tight manner into a corresponding needle seat. Alternatively or in addition, image information as provided by the detection unit can be applied for determining the actual position of the needle (or needle tip), e.g. using image recognition. In other words, the detection unit determines the actual position of the needle (or needle tip), for example by applying image recognition. Alternatively or in addition, a respective sensor can be applied, for example for detecting a deviation in actual positioning or in the actual shape of the needle (or needle tip) e.g. resulting from bending the needle. Such sensor may be an optical or capacitive sensor applied for determining a distance between a reference point (of or in the sensor) and a respective point or position of the needle (or needle tip). It is clear that any other method can be applied accordingly in order to determine the actual position of the needle (or needle tip) in order to ensure that the needle (or needle tip) can actually and sufficiently accurately hit the determined target position e.g. for penetrating into the receptacle.

In one embodiment, the receptacle has a body for containing the fluid and an opening (e.g. an entry area or mouth) for reaching into the receptacle. The marking is preferably positioned on the receptacle in a spatially defined relationship to the opening into the receptacle, so that preferably the at least one feature has a defined spatial relationship to the opening and preferably to a center point of the opening. In preferred applications, the marking can be sufficiently accurately positioned on the receptacle, which can be ensured by applying state-of-the-art positioning of the marking, such as to apply a sufficiently accurate printing (or other type of depositing) of the marking on the receptacle, such as on an upper surface of a cap or other coverage of the receptacle. With the marking being sufficiently accurately positioned with respect to the opening of the receptacle, the positioning of the needle (with respect to the receptacle) can be applied in the sense of a positioning of the needle (or e.g. a needle tip) with respect to the marking. In other words, the positioning of the needle according to embodiments of the present invention is provided with respect to the marking (and not in respect of an optical recognition of the receptacle as such).

In such embodiments, the target position can be selected to be in spatial relationship to the center point of the opening, preferably the target position can be selected to be the center point of the opening.

In one embodiment, the needle comprises an elongated shape with an open end for fluid aspiration and/or dispensing, and may be or comprise at least one of a conduit and a nozzle. The open end may be preferably coupled to another open end of a fluid path, preferably a needle seat, in a fluid-tight manner. The needle may have a sharpened end e.g. configured for penetrating through a surface (e.g. a cap or other coverage covering the receptacle), but may also be embodied without such sharpened end, e.g. having a blunt end. Further, while the needle is preferably embodied using a substantially rigid material, such as a metal (e.g. stainless steel), ceramic, et cetera, softer materials may be applied as well e.g. allowing to bend the needle (e.g. in the sense of a soft(er) tubing).

In one embodiment, the receptacle is or comprises at least one of: a container, a vial, a vessel, a tube, a microtiter plate. The receptacle may comprise one or more individual wells each for receiving and storing a respective fluid. As an example, a microtiter plate may comprise e.g. 96 wells, 384 wells, or the like.

In one embodiment, the needle drive comprises at least one of: a linear stage, an xyz-robot, a robot arm, a manipulator.

In one embodiment, the needle drive is configured for immersing the needle into the receptacle, preferably into the fluid contained within the receptacle.

In one embodiment, the marking is or comprises at least one of: a fiducial, a fiducial mark, a barcode preferably EAN, a 2D barcode preferably a QR code, Aztec code, or any other machine-readable label or marking.

In one embodiment, the marking is located on a surface of the receptacle, such as an upper surface, a lateral surface, or a lower or bottom surface of the receptacle. In case the receptacle comprises a plurality of individual wells (each for receiving and storing a respective fluid), the receptacle may comprise a respective marking assigned to each respective well. Alternatively, a plurality of wells may be related to a respective marking. In one embodiment, the receptacle comprises only one single marking related to each of the plurality of wells and allowing to determine a respective target position for each respective one of the plurality of wells based on the one single marking. Such single marking (for a plurality of wells) is preferably provided on a lateral side and/or a lower or bottom side of the receptacle. In an example of a microtiter plate (e.g. with 96, 384 or the like wells) as the receptacle, a single marking is provided on a bottom side of the microtiter plate allowing to determine the respective target position (for penetrating into the respective well) for each of the plurality of wells. Additional information about the receptacle may be used for such determination, for example information about the geometry (preferably including tolerances) of the receptacle.

In one embodiment, the marking is located on an upper surface of the receptacle, preferably on at least one of a cap, lid, flap, coverage, foil, seal, wherein preferably the upper surface is at or in the area of an opening of the receptacle

In one embodiment, the marking is provided as a label, a sticker, or a tag, and/or is applied by printing, stamping, or laser marking, preferably on the receptable, whereby it may contain at least one material of the group: an ink, a dye, fluorescent dye, a dielectric material, a metal, a magnetic material, a polymer, a polarizable material, a molten polymer printing, preferably of different color than the surface of the receptable.

In one embodiment, the marking is part of the receptacle, preferably part of at least one of a cap, lid, flap, coverage, foil, seal of the receptacle, e.g. as provided by directly during a molding process of the vial cap.

In one embodiment, the marking comprises an RFID antenna or RFID tag.

In one embodiment, the marking is provided by an indentation into and/or elevation on the receptacle, preferably an upper surface of the receptacle. This may be provided e.g. by injection molding, imprinting, or laser engraving.

In one embodiment, the detection unit comprises at least one of: an optical detection unit, a fluorescence detection unit, a phosphorescence detection unit, a luminescence detection unit, a magnetic detection unit, a microwave detection unit.

In one embodiment, the detection unit is configured for detecting the marking by providing at least one of: an image recognition, fluorescence imaging, reading dielectric barcodes, reading magnetic structures. It is clear to one skilled in the art, that image recognition in conjunction with suitable image analysis algorithms might also be used to detect for instance engraved imprints.

In one embodiment, the detection unit is configured for detecting the marking of the receptacle when the receptacle is located in a dedicated detection area of the fluid handling unit where the detection unit is capable of detecting the receptacle.

In one embodiment, the at least one feature to be determined by the control unit is at least one of: a point, a middle point, one or more edges of a geometric object, a geometrical shape preferably a circle, square, rectangle, triangles or the like.

In one embodiment, the control unit is configured for operating the needle drive to position the open end of the needle relative to the determined target position above the receptacle, and for moving the needle towards the marking in order to contact (e.g. hit or touch) the determined target position with the open end of the needle.

In one embodiment, the control unit is configured for operating the needle drive to position the open end of the needle into the receptacle for aspirating and/or dispensing the fluid from or into the receptacle.

In one embodiment, the fluid handling unit is configured for handling a fluid in a chromatography system comprising a mobile phase drive and a separation unit. The mobile phase drive is configured for driving a mobile phase through the separation unit, and the separation unit is configured for chromatographically separating compounds of a sample fluid in the mobile phase. The fluid is contained or to be contained in a receptacle bearing a marking. The fluid is at least one of: the sample fluid to be injected into the mobile phase and separated compounds of the sample fluid.

One embodiment comprises a chromatography system comprising a mobile phase drive and a separation unit. The mobile phase drive is configured for driving a mobile phase through the separation unit, and the separation unit is configured for chromatographically separating compounds of a sample fluid in the mobile phase. The chromatography system further comprises a fluid handling unit according to any one of the aforedescribed embodiments, wherein the fluid handling unit is configured for handling a fluid contained or to be contained in a receptacle bearing a marking, and the fluid is at least one of: the sample fluid to be injected into the mobile phase and separated compounds of the sample fluid.

One embodiment comprises a receptacle to be used in a chromatography system e.g. the aforedescribed chromatography system. The receptacle comprises a marking configured to be for determining at least one feature being part of the marking or the marking itself for determining a target position based on the detected at least one marking, in order to operate a needle drive to (spatially) position an open end of a needle relative to the determined target position.

The receptacle may have a body for containing the fluid and an opening (e.g. an entry area or mouth) for reaching into the receptacle. The marking is preferably positioned on the receptacle in a spatially defined relationship to the opening into the receptacle, so that preferably the at least one feature has a defined spatial relationship to the opening and preferably to a center point of the opening. In preferred applications, the marking can be sufficiently accurately positioned on the receptacle, which can be ensured by applying state-of-the-art positioning of the marking, such as to apply a sufficiently accurate printing (or other type of depositing) of the marking on the receptacle, such as on an upper surface of a cap or other coverage of the receptacle. With the marking being sufficiently accurately positioned with respect to the opening of the receptacle, the positioning of the needle (with respect to the receptacle) can be applied in the sense of a positioning of the needle (or e.g. a needle tip) with respect to the marking. In other words, the positioning of the needle according to embodiments of the present invention is provided with respect to the marking (and not in respect of an optical recognition of the receptacle as such).

One embodiment of the present invention is a method for positioning a needle with respect to a receptacle for aspirating a fluid contained in the receptacle and/or dispensing a fluid into the receptacle, wherein the receptacle bears a marking. The method comprises detecting the marking of the receptacle, analysing the detected marking for determining (e.g. detecting, calculating, recognizing) at least one feature being part of the marking or the marking itself, determining a target position based on the detected at least one feature, and positioning the needle relative to the determined target position.

In one embodiment, the method further comprises correcting a deviation of an actual position from the determined target position of an open end of the needle, preferably by determining the deviation by using at least one of: an image recognition, a capacitive measurement, and an inductive measurement. Without correcting the deviation, the open end of the needle would not hit the determined target position when being moved toward the target position. The method may further comprise operating the needle drive to correct for the determined deviation, so that after correction of the deviation the open end of the needle would hit the determined target position when being moved toward the target position.

In one embodiment, the method further comprises detecting the marking by providing at least one of: an image recognition, reading dielectric barcodes, reading magnetic structures.

In one embodiment, the method further comprises detecting the marking of the receptacle when the receptacle is located in a dedicated detection area of the fluid handling unit where the detection unit is capable of detecting the receptacle.

In one embodiment, the method further comprises positioning an open end of the needle relative to the determined target position above the receptacle.

In one embodiment, the method further comprises moving the needle towards the marking in order to contact (e.g. hit or touch) the determined target position with an open end of the needle.

In one embodiment, the method further comprises positioning an open end of the needle into the receptacle for aspirating and/or dispensing the fluid.

Embodiments of the present invention might be embodied based on most conventionally available HPLC systems, such as the Agilent 1220, 1260 and 1290 Infinity LC Series (provided by the applicant Agilent Technologies).

The separating device preferably comprises a chromatographic column providing the stationary phase. The column might be a glass, metal, ceramic or a composite material tube (e.g. with a diameter from 50 μm to 5 mm and a length of 1 cm to 1 m) or a microfluidic column (as disclosed e.g. in EP 1577012 A1 or the Agilent 1200 Series H PLC-Chip/MS System provided by the applicant Agilent Technologies). The individual components are retained by the stationary phase differently and separate from each other while they are propagating at different speeds through the column with the eluent. At the end of the column they elute at least partly separated from each other. During the entire chromatography process the eluent might be also collected in a series of fractions. The stationary phase or adsorbent in column chromatography usually is a solid material. The most common stationary phase for column chromatography is silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are microporous for an increased surface, which can be especially chemically modified, though in EBA a fluidized bed is used.

The mobile phase (or eluent) can be either a pure solvent or a mixture of different solvents. It can also contain additives, i.e. be a solution of the said additives in a solvent or a mixture of solvents. It can be chosen e.g. to adjust the retention of the compounds of interest and/or the amount of mobile phase to run the chromatography. The mobile phase can also be chosen so that the different compounds can be separated effectively. The mobile phase might comprise an organic solvent like e.g. methanol or acetonitrile, often diluted with water. For gradient operation water and organic solvent is delivered in separate containers, from which the gradient pump delivers a programmed blend to the system. Other commonly used solvents may be isopropanol, THF, hexane, ethanol and/or any combination thereof or any combination of these with aforementioned solvents.

The sample fluid might comprise any type of process liquid, natural sample like juice, body fluids like plasma or it may be the result of a reaction like from a fermentation broth.

The fluid is preferably a liquid but may also be or comprise a gas and/or a supercritical fluid (as e.g. used in supercritical fluid chromatography—SFC—as disclosed e.g. in U.S. Pat. No. 4,982,597 A).

The pressure in the mobile phase might range from 2-200 MPa (20 to 2000 bar), in particular 10-150 MPa (100 to 1500 bar), and more particular 50-130 MPa (500 to 1300 bar).

The HPLC system might further comprise a detector for detecting separated compounds of the sample fluid, a fractionating unit for outputting separated compounds of the sample fluid, or any combination thereof. Further details of HPLC system are disclosed with respect to the aforementioned Agilent HPLC series, provided by the applicant Agilent Technologies.

Embodiments of the invention can be partly or entirely embodied or supported by one or more suitable software programs or products, which can be stored on or otherwise provided by any kind of data carrier, and which might be executed in or by any suitable data processing unit. Software programs or routines can be preferably applied in or by the control unit, e.g. a data processing system such as a computer, preferably for executing any of the methods described herein.

In the context of this application, the term “fluidic sample” may particularly denote any liquid and/or gaseous medium, optionally including also solid particles, which is to be analyzed. Such a fluidic sample may comprise a plurality of fractions of molecules or particles which shall be separated including biomolecules such as proteins. Since separation of a fluidic sample into fractions involves a certain separation criterion (such as mass, volume, chemical or physical properties, etc.) according to which a separation is carried out, each separated fraction may be further separated by another separation criterion (such as mass, volume, chemical or physical properties, etc.) or finer separated by the first separation criterion, thereby splitting up or separating a separate fraction into a plurality of sub-fractions.

In the context of this application, the term “fraction” may particularly denote such a group of molecules or particles of a fluidic sample which have one or more certain properties of the group of: mass, charge, volume, chemical or physical properties or interaction, etc. in common according to which the separation has been carried out. However, molecules or particles relating to one fraction can still have some degree of heterogeneity, i.e. can be further separated in accordance with another separation criterion. Further, layering due to density differences may occur within one or more fractions. The term “fraction” may denote a portion of a solvent containing the aforementioned group of molecules.

In the context of this application, the term “sample separation apparatus”, “fluid separation apparatus” or similar may particularly denote any apparatus which is capable of separating different fractions of a fluidic sample by applying a certain separation technique. Particularly, two separation apparatus may be provided in such a sample separation apparatus when being configured for a two-dimensional separation. This means that the sample is first separated in accordance with a first separation criterion, and at least one or some of the fractions resulting from the first separation are subsequently separated in accordance with a second, different, separation criterion or more finely separated in accordance with the first separation criterion.

The term “separation unit”, “separation device” or similar may particularly denote a fluidic member through which a fluidic sample is transferred, and which is configured so that, upon conducting the fluidic sample through the separation unit, the fluidic sample will be separated into different groups of molecules or particles (called fractions or sub-fractions, respectively). An example for a separation unit is a liquid chromatography column which is capable of trapping or retaining and selectively releasing different fractions of the fluidic sample.

In the context of this application, the term “fluid drive”, “mobile phase drive” or similar may particularly denote any kind of pump which is configured for forcing a flow of mobile phase and/or a fluidic sample along a fluidic path. A corresponding liquid supply system may be configured for delivery of a single liquid or of two or more liquids in controlled proportions and for supplying a resultant mixture as a mobile phase. It is possible to provide a plurality of solvent supply lines, each fluidically connected with a respective reservoir containing a respective liquid, a proportioning valve interposed between the solvent supply lines and the inlet of the fluid drive, the proportioning valve configured for modulating solvent composition by sequentially coupling selected ones of the solvent supply lines with the inlet of the fluid drive, wherein the fluid drive is configured for taking in liquids from the selected solvent supply lines and for supplying a mixture of the liquids at its outlet. More particularly, the first fluid drive can be configured to drive the fluidic sample, usually mixed with, or injected into a flow of a mobile phase (solvent composition), through the first-dimension separation apparatus, whereas the second fluid drive can be configured for driving the fluidic sample fractions, usually mixed with a further mobile phase (solvent composition), after treatment (e.g. elution) by the first-dimension separation unit through the second-dimension separation apparatus.

In the context of this application, the term “valve” or “fluidic valve” may particularly denote a fluidic component which has fluidic interfaces, wherein upon switching the fluidic valve selective ones of the fluidic interfaces may be selectively coupled to one another so as to allow fluid to flow along a corresponding fluidic path, or may be decoupled from one another, thereby disabling fluid communication.

In the context of this application, the term “buffer” or “buffering” may particularly be understood as temporarily storing. Accordingly, the term “buffering fluid” is preferably understood as temporarily storing an amount of fluid, which may later be fully or partly retrieved from such unit buffering the fluid.

In the context of this application, the term “loop” may particularly be understood as a fluid conduit allowing to temporarily store an amount of fluid, which may later be fully or partly retrieved from the loop. Preferably, such loop has an elongation along the flow direction of the fluid and a limited mixing characteristic (e.g. resulting from dispersion), so that a spatial variation in composition in the fluid will be at least substantially maintained along the elongation of the loop. Accordingly, the term “sample loop” may be understood as a loop configured to temporarily store an amount of sample fluid. Further accordingly, a sample loop is preferably configured to at least substantially maintain a spatial variation in the sample fluid (along the flow direction of the sample), as e.g. resulting from a previous chromatographic separation of the sample fluid, during temporarily storing of such sample fluid.

In the context of this application, the term “retain”, “retaining”, or similar, in particular in context with “unit”, may particularly be understood as providing a surface (e.g. a coating) and/or a stationary phase configured for interacting with a fluid in the sense of having a desired retention characteristics with one or more components contained in the fluid. Such desired retention characteristics shall be understood as an intentionally applied retention, i.e. a retention beyond an unintentional side-effect. Accordingly, the term “retaining unit” may be understood as a unit in a fluidic path being configured for interacting with a sample fluid for providing a desired retention characteristic for one or more components contained in the sample fluid.

In the context of this application, the term “couple”, “coupled”, “coupling”, or similar, in particular in context with “fluidic” or “fluidically”, may particularly be understood as providing a fluidic connection at least during a desired time interval. Such fluidic connection may not be permanent but allows a (passive and/or active) transport of fluid between the components fluidically coupled to each other at least during such desired time interval. Accordingly, fluidically coupling may involve active and/or passive components, such as one or more fluid conduits, switching elements (such as valves), et cetera.

The fluid separation apparatus may be configured to drive the mobile phase through the system by means of a high pressure, particularly of at least 400 bar, more particularly of at least 1000 bar.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 illustrates a liquid chromatography system according to an exemplary embodiment.

FIG. 2 illustrates a preferred embodiment of a sample injector according to the present invention.

FIG. 3 shows a partial view of an embodiment of the fluid handling unit.

FIG. 4 shows in greater detail an embodiment of a receptacle.

FIG. 5 shows an example of a detected QR code.

FIG. 6 illustrates an embodiment for correcting a deviation of an actual position of a needle tip with respect to a determined target position.

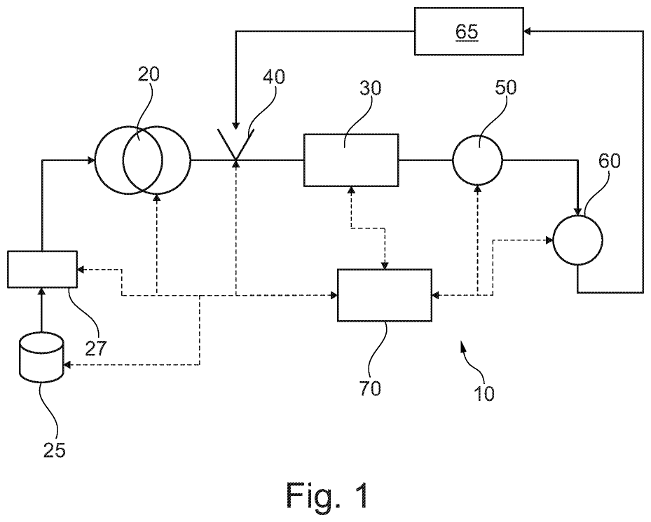

Referring now in greater detail to the drawings, FIG. 1 depicts a general schematic of a liquid separation system 10. A mobile phase drive 20 (such as a pump) receives a mobile phase from a solvent supply 25, typically via a degasser 27, which degases the mobile phase and thus reduces the amount of dissolved gases in it. The mobile phase drive 20 drives the mobile phase through a separating device 30 (such as a chromatographic column). A sample injector 40 (also referred to as sample introduction apparatus, sample dispatcher, etc.) is provided between the mobile phase drive 20 and the separating device 30 in order to subject or add (often referred to as sample introduction) portions of one or more sample fluids into the flow of a mobile phase. The separating device 30 is adapted for separating compounds of the sample fluid, e.g. a liquid. A detector 50 is provided for detecting separated compounds of the sample fluid. A fractionating unit 60 can be provided for dispensing separated compounds of sample fluid.

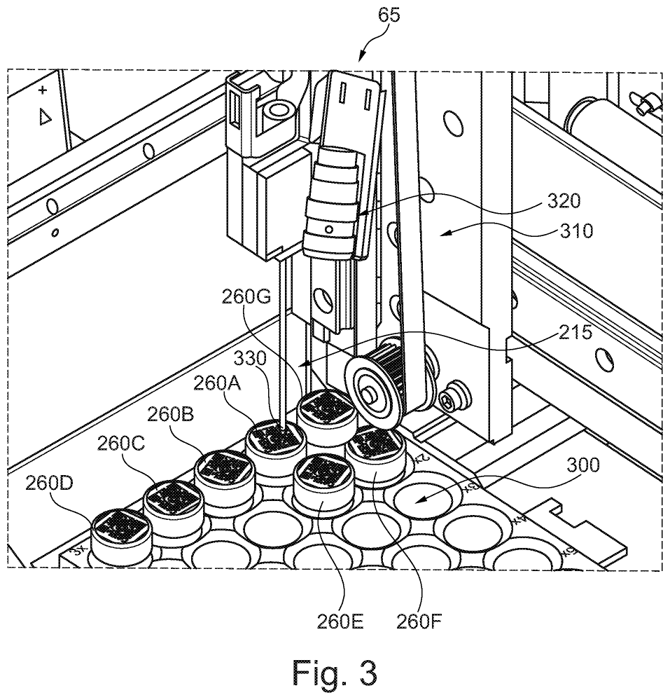

In one embodiment, at least parts of the sample injector 40 and the fractionating unit 60 can be combined into a fluid handling unit 65, e.g. in the sense that some common hardware is used as applied by both of the sample injector 40 and the fractionating unit 60. The fluid handling unit 65 can provide functions of both, the sample injector 40 and the fractionating unit 60, e.g. handling sample fluid typically contained in a respective receptacle (container, vessel, vial, et cetera) for aspirating the sample fluid and injecting such aspirated sample fluid into the flow of the mobile phase from the mobile phase drive 20. This may include handling of plural receptacles each containing a respective sample fluid to be injected. Further or alternatively, the fluid handling unit 65 may also be configured to receive separated compounds of sample fluid dispensed by the fractionating unit 60, e.g. for dispensing into one or more receptacles. Such dispensed fluid (e.g. the separated compounds of sample fluid) may then be handled by the fluid handling unit 65 e.g. for re-injection into the mobile phase or for depositing the respective receptacle either internally or externally with respect to the liquid separation system 10. Parts of the fluid handling unit 65 will be depicted in greater detail in FIG. 3.

The separating device 30 may comprise a stationary phase configured for separating compounds of the sample fluid. Alternatively, the separating device 30 may be based on a different separation principle (e.g. field flow fractionation).

While the mobile phase can be comprised of one solvent only, it may also be mixed of plurality of solvents. Such mixing might be a low pressure mixing and provided upstream of the mobile phase drive 20, so that the mobile phase drive 20 already receives and pumps the mixed solvents as the mobile phase. Alternatively, the mobile phase drive 20 might be comprised of plural individual pumping units, with plural of the pumping units each receiving and pumping a different solvent or mixture, so that the mixing of the mobile phase (as received by the separating device 30) occurs at high pressure and downstream of the mobile phase drive 20 (or as part thereof). The composition (mixture) of the mobile phase may be kept constant over time, the so-called isocratic mode, or varied over time, the so-called gradient mode.

A data processing unit 70, which can be a conventional PC or workstation, a thin client, a laptop, a netbook, a tablet, a smartphone, a smartwatch, a server including a cloud server or the like, might be coupled (as indicated by the dotted arrows) to one or more of the devices in the liquid separation system 10 in order to receive information and/or control operation. For example, the data processing unit 70 might control operation of the mobile phase drive 20 (e.g. setting control parameters) and receive therefrom information regarding the actual working conditions (such as output pressure, flow rate, etc. at an outlet of the pump). The data processing unit 70 might also control operation of the solvent supply 25 (e.g. monitoring the level or amount of the solvent available) and/or the degasser 27 (e.g. setting control parameters such as vacuum level) and might receive therefrom information regarding the actual working conditions (such as solvent composition supplied over time, flow rate, vacuum level, etc.). The data processing unit 70 might further control operation of the sample injector 40 (e.g. controlling sample introduction or synchronization of the sample introduction with operating conditions of the mobile phase drive 20). The separating device 30 might also be controlled by the data processing unit 70 (e.g. selecting a specific flow path or column, setting operation temperature, etc.), and send—in return—information (e.g. operating conditions) to the data processing unit 70. Accordingly, the detector 50 might be controlled by the data processing unit 70 (e.g. with respect to spectral or wavelength settings, setting time constants, start/stop data acquisition), and send information (e.g. about the detected sample compounds) to the data processing unit 70. The data processing unit 70 might also control operation of the fractionating unit 60 (e.g. in conjunction with data received from the detector 50) and provides data back. The data processing unit 70 might also process the data received from the system or its part and evaluate it in order to represent it in adequate form prepared for further interpretation.

The data processing unit 70 is preferably configured to control operation of the fluid handling unit 65, e.g. for handling sample fluid (typically contained in a respective receptacle) such as aspirating the sample fluid and/or injecting such aspirated sample fluid into the flow of the mobile phase from the mobile phase drive 20. The data processing unit 70 may also control handling of plural receptacles each containing a respective sample fluid to be injected. Further, the data processing unit 70 may control receiving separated compounds of sample fluid dispensed by the fractionating unit 60, e.g. for dispensing into one or more receptacles. The data processing unit 70 may further control handling such dispensed fluid (e.g. the separated compounds of sample fluid) by the fluid handling unit 65 e.g. for re-injection into the mobile phase or for depositing the respective receptacle either internally or externally with respect to the liquid separation system 10.

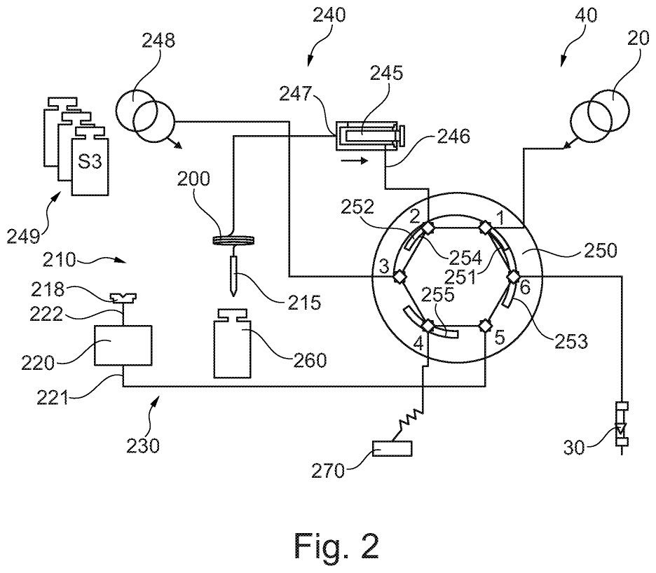

FIG. 2 illustrates a preferred embodiment of a sample injector 40 according to the present invention, comprising: a sampling volume 200, a sampling unit 210 comprised of a needle 215 and a needle seat 218, and an optional retaining unit 220, all arranged in a serial connection and providing a sampling path 230. Further coupled to the sampling path 230 is a sampling fluid drive 240, which in the embodiment of FIGS. 2 is comprised of a metering device 245 and an optional fluid pump 248. The fluid pump 248 may be coupled to one or more solvent reservoirs 249 as schematically indicated in the drawings. A switching unit 250 is coupled to the sampling path 230, the sampling fluid drive 240, the mobile phase drive 20, and the separating device 30.

The sampling volume 200 is configured for temporarily storing an amount of the received fluidic sample, and can be any of a sample loop, a sample volume, a trap volume, a trap column, a fluid reservoir, a capillary, a tube, a microfluidic channel structure. The retaining unit 220 is configured for receiving and retaining from the sampling volume 200 at least a portion of the fluidic sample stored in the sampling volume 200. The retaining unit 220 may be further configured to show different retention characteristics for different components of the fluidic sample.

FIG. 2 shows an open position of the sampling unit 210 wherein the needle 215 is physically separated from the needle seat 218, thus allowing the needle 215 to receive a fluidic sample e.g. from a receptacle 260 (e.g. a vessel or vial) as indicated in the exemplary representation of FIG. 2.

In the exemplary embodiment of FIG. 2, the switching unit 250 is a rotational valve having a stator and a rotor. The stator has six ports (indicated by reference numerals 1-6 and each port allowing to couple e.g. a fluid conduit thereto, a first static groove 251, and a second static groove 252. The first static groove 251 extends from port 1, and the second static groove 252 extends from port 2. The rotor comprises a first (dynamic) groove 253, a second (dynamic) groove 254, and a third (dynamic) groove 255. It is clear that other valve configurations may be applied accordingly.

In FIG. 2, the mobile phase drive 20 is coupled to port 1, a first end 246 of the metering device 245 is coupled to port 2 while a second end 247 of the metering device 245 is coupled to the sampling volume 200. The fluid pump 248 is coupled to port 3. Port 4 is coupled to waste or any other fluidic unit as indicated by reference numeral 270. Port 5 is coupled to a first end 221 of the retaining unit 220 while the second end 222 of the retaining unit 220 is coupled to the needle seat 218. Port 6 is coupled to the separating device 30.

In FIG. 2, the switching unit 250 is shown in switching configuration for loading the sample fluid into the sampling volume 200 before being injected into the mobile phase. The first groove 253 is coupling between ports 1 and 6, thus coupling the mobile phase drive 20 to the separating device 30, so that the mobile phase drive 20 drives the mobile phase through the switching unit 250 and the separating device 30. The first groove 253 is overlapping with the first static groove 251. The second groove 254 and the second static groove 252 are overlapping with each other but not reaching to any other port, so that port 2 is blocked, and thus also the first end 246 of the metering device 245 is blocked.

When the needle 215 will be immersed into the sample fluid within the receptacle 260 (not shown FIG. 2), the metering device 245 can be operated to provide a backwards movement (as indicated by the arrow in FIG. 2A) allowing the needle 215 to aspirate or retrieve sample fluid from the receptacle 260 (e.g. when the needle 215 is immersed into the receptacle 260). By further backwards movement of the needle 215, the received sample fluid will also be drawn into the sampling volume 200 and can be temporarily stored therein.

By rotating the rotor with respect to the stator (not further shown in FIG. 2), the switching unit 250 can be operated into multiple other switching configurations, e.g. for allowing a so-called feed injection of buffered sample fluid into the mobile phase, for example by rotating the rotor so that the first groove 253 together with the first static groove 251 are coupling ports 1, 6, and 5 fluidically together and representing a coupling point. When the metering device 245 is applying a forward movement, fluid content contained in the sampling volume 200 can be pushed (fed) into the mobile phase. In other words, a flow within the sampling path 230 is combined in the coupling point with a flow of the mobile phase from the mobile phase drive 20, and the combined flow is provided towards the separating device 30.

By further rotating the rotor with respect to the stator (not further shown in FIG. 2), the switching unit 250 can be operated for allowing a so-called flow through injection of buffered sample fluid into the mobile phase. The first groove 253 is coupling between ports 1 and 2, and the third groove 255 is coupling between ports 5 and 6, so that the sampling path 230 (together with the metering device 245) is switched between the mobile phase drive 20 and the separating device 30. Accordingly, any sample fluid within the sampling path 230 and in particular within the sampling volume 200 will be transported by the mobile phase provided from the mobile phase drive 20 towards and through the separating device 30. In an alternate embodiment, e.g. a so-called fixed loop injection, not shown here, the metering device 245 can be separated from the sampling path 230, so that only the sampling path 230 will be switched between the mobile phase drive 20 and the separating device 30.

FIG. 3 shows a partial view of an embodiment of the fluid handling unit 65, as far as relevant here for the sake of understanding the present invention. The fluid handling unit 65, as shown here, comprises the needle 215 (preferably an injection needle), shown in the open position is also shown in FIG. 2, a plurality of receptacles 260A-260G (preferably vials) contained in a tray 300 (preferably a vial tray), a needle drive 310, and a camera 320. It is clear that the fluid handling unit 65 may contain other components which, however, are not detailed in the representation of FIG. 3.

The needle 215 has an essentially elongated shape with an open end, a needle tip 330, and is configured for aspirating fluid from any of the receptacles 260A-260G and/or dispensing the fluid into any of the receptacles 260A-260G.

The needle drive 310 is configured for spatially positioning the needle 215 with in the fluid handling unit 65. The needle drive 310 preferably comprises one or more of a linear stage, an xyz-robot, a robot arm, a manipulator, et cetera, allowing to position the needle 215 as readily known in the art and which does not need to be detailed here. Preferably, the needle drive 310 allows immersing the needle 215 into the respective receptacle 260 as well as removing the needle 215 from being immersed into the receptacle 260. The needle drive 310 may also allow to position the needle 215 into the needle seat 218, preferably in a fluid tight manner, thus allowing to prepare the sample injector 40 for injecting sample fluid into the mobile phase.

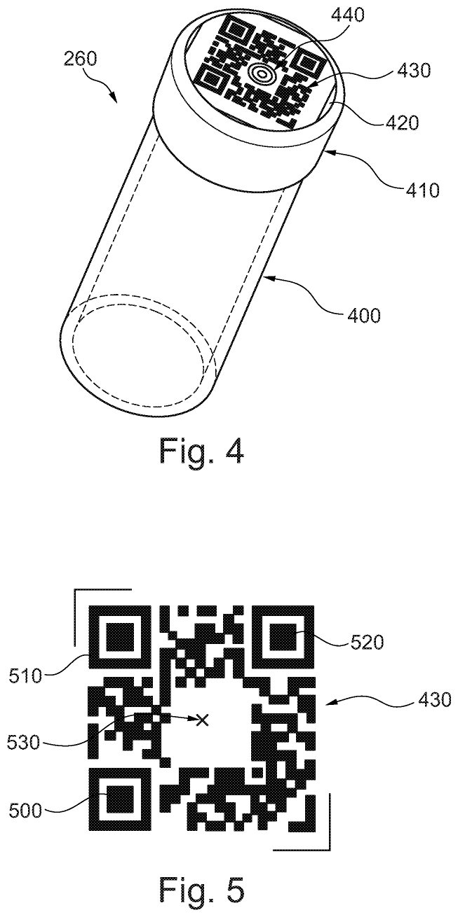

FIG. 4 shows in greater detail an embodiment of the receptacle 260. The receptacle 260 has a body 400 for containing fluid. A cap 410 is covering an opening (not visible in FIG. 4) of the body 400 for reaching into the body 400 of the receptacle 260. The cap 410 has an upper surface 420 bearing a marking 430 which may comprise an optional alignment fiducial 440.

Such caps 410 are often used in analytical applications, such as the liquid separation system 10, to seal the receptacle 260 e.g. to avoid evaporation of sample fluid. The cap 410 may comprise in its center a membrane which can be penetrated by the needle 215 to aspirate sample out of the receptacle 260. In certain embodiments, tapered vial inserts are used to minimise the sample volume inside the receptacle 260. This represents a receptacle in the receptacle or, in other words, a vial in a vial. In such embodiments, it is important that the needle 215 is exactly positioned in the center of the cap 410 e.g. to avoid collision with the vial insert.

The marking 430 as shown in the embodiment of FIG. 4 is a QR code as readily known in the art. Such markings 430 are often applied to identify and track respective sample receptacles 260 e.g. within a sample injection module 40. Instead of QR code, other types of identification codes, such as a fiducial, a fiducial mark, a barcode preferably EAN, a 2D barcode preferably a QR code, Aztec code, or any other machine-readable label or marking may be applied accordingly. Also, the marking 430 (or additional identifiers) may also be provided on any other surface of the receptacle 260. The marking 430 may be printed or otherwise be provided on the receptacle 260. The marking 430 may be provided for optical recognition, but other recognition types, such as magnetic recognition or microwave recognition, may be applied accordingly. The material applied for the marking 430 depends accordingly on the applied recognition type. In case of optical recognition, ink or other type of dye may be applied. Also, specific detection types such as fluorescence, phosphorescence, magnetic, or microwave detection may be applied accordingly.

Returning to FIG. 3, the detection unit 320 is configured for detecting the marking 430 on the respective one of the receptacles 260A-260G. In the example here, the marking of the receptacle 260A is to be detected by the detection unit 320. Such detection can be provided using e.g. image recognition as readily known in the art. Dependent on the detection type of the marking 430, other recognition types than optical recognition can be applied accordingly.

In order to spatially position the needle 215 into the receptacle 260A (in the example of FIG. 3), the precise position of the center of the upper surface 420 of the cap 410 needs to be determined, thus allowing the needle drive 310 to penetrate the needle 215 through such detected center and to immerse into the receptacle 260A. Any deviation from the precise position of the center may jeopardize the process of immersing the needle 215 into the receptacle 260A and may even lead to a collision e.g. of the needle tip 330 with a wall of the receptacle 260A or with a respective insert into the receptacle 260A.

It has been shown that an optical recognition process of the receptacle 260 may not be sufficient in real life situations to sufficiently securely position the needle 215 into the receptacle 260, e.g. as resulting from varying light conditions, reflecting surfaces, stray light, dirt, or others. To overcome such limitations, the invention applies an additional determining process in order to reliably position the needle 215 into the receptacle 260. Such determining process is based on the assumption that the marking 430 can be sufficiently accurately positioned on the receptacle 260, which can be ensured by applying state-of-the-art positioning of the marking 430, such as to apply a sufficiently accurate printing (or other type of depositing) of the marking 430 on the upper surface 420 of the cap 410.

With the assumption that the marking 430 is sufficiently accurately positioned with respect to the opening of the receptacle 260, the positioning of the needle 215 (with respect to the receptacle 260) can be applied in the sense of a positioning of the needle 215 (or better of the needle tip 330) with respect to the marking 430. In other words, the positioning of the needle 215 according to the present invention is provided with respect to the marking 430 (and not in respect of an optical recognition of the receptacle 260 as such).

Turning back to FIG. 3, in order to spatially position the needle 215 into the receptacle 260A, the control unit 70 analyses the information of the detected marking 430 as provided by the camera (detection unit) 320 in order to detect at least one feature for geometrical positioning. In the example here, the camera 320 has detected the QR code of the marking 430, as shown in FIG. 5. The control unit 70 analyses the detected marking 430 and determines three features 500, 510, and 520, namely the three rectangular patterns (e.g. including an outer rectangular black line with an inner rectangular black box, or only the outer rectangular black line, or only the inner rectangular black box) in the outer corners of the marking 430. Preferably, the exact size and shape of the features is determined to proceed. Alternatively, the inner or outer edges of the features may be determined. With such determined features 500, 510, and 520, the control unit 70 can further determine a target position 530 to which the needle tip 330 shall be positioned in order to penetrate the needle 215 into the receptacle 260. While such target position 530 preferably is the center of the marking 430, it is clear that the respective position of the target position 530 depends on the specifics of the used receptacle 260. Also, it is clear that the number of features required to sufficiently accurately determine the target position 530 also depends on the specifics of the used type of marking 430. In the present example of a QR code as marking 430, two of the determined features 500, 510, and 520 would already be sufficient to determine the center of the marking 430 as the target position 530. However, accuracy of determining the target position 530 can be increased by using more than two of the determined features 500, 510, and 520, preferably by using the three determined features 500, 510, and 520.

In the exemplary embodiment of FIG. 4, the marking 430 additionally contains an optional alignment fiducial 440, which may be applied accordingly in order to determine the target position 530. In the example of FIG. 4 with the alignment fiducial 440 being provided by a plurality of concentric circles, the center of such concentric circles, as can be easily determined from such plurality of concentric circles, shall represent the target position 530.

It is clear that more than one marking can be used for determining the target position 530, such as both of the marking 430 and the alignment fiducial 440 as shown in FIG. 4. Accuracy of positioning may be increased by using and analysing plural such markings.

In the exemplary embodiment of FIG. 4, the alignment fiducial 440 is not part of the information containing QR code but rather represents an additional fiducial. In other words, the QR code in FIG. 4 solely contains the information e.g. for identifying the content of the receptacle 260, while the alignment fiducial 440 is purely provided for finding the target position 530.

It is clear that the number of features for sufficiently accurately determining the target position 530 as well as whether a respective alignment fiducial 440 is part of an information containing marking 430 or not depends on the specifics of the chosen type of marking, type of detection, and/or the required accuracy of the target position 530.

Once the target position 530 has been determined by the control unit 70, the control unit 70 can operate the needle drive 310 to spatially position the needle tip 330 relative to the determined target position 530, preferably by positioning the needle tip 330 precisely onto the target position 530. The control unit 70 can then operate the needle drive 310 to lower the needle 215 into the receptacle 260 in the sense of penetrating the needle 215 through the target position 530 on the upper surface 420 of the cap 410 and into the body 400 of the receptacle 260. With the needle 215 thus immersing into the receptacle 260, the control unit 70 may then operate the metering device 245 to aspirate fluid from inside of the receptacle 260, e.g. into the sampling volume 200. Alternatively, with the needle 215 being immersed into the receptacle 260, the control unit 70 may operate the fractionating unit 60 to dispense portions of separated sample fluid into the receptacle 260.

As apparent from the described embodiment above, the needle 215 can be safely and sufficiently accurately aligned to the center of the receptacle 260, either by analysing an information containing part of the marking 430 and/or by analysing the alignment fiducial 440 which may also be subject of the information containing part of the marking 430.

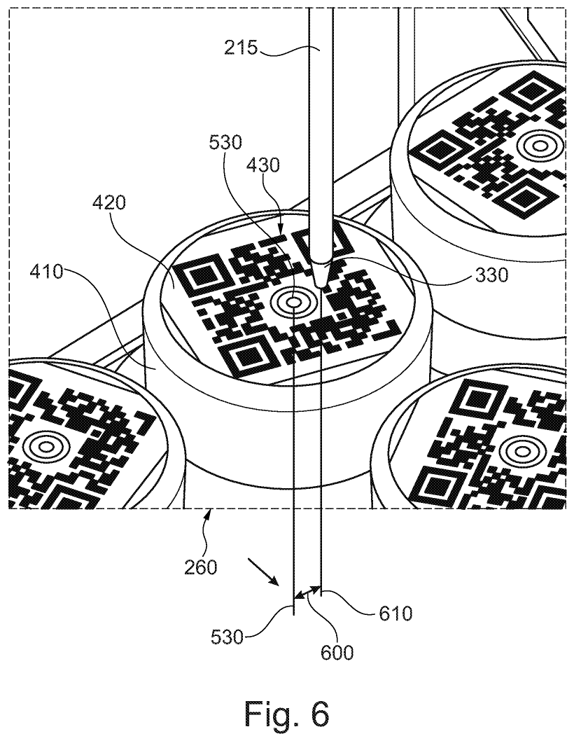

FIG. 6 illustrates an embodiment for correcting a deviation 600 of an actual position 610 of the needle tip 330 with respect to the determined target position 530. Such deviation may result e.g. from bending or misalignment of the needle 215 or any other inaccuracy or tolerance in the fluid handling unit 65, in particular in the needle drive 310. For determining the deviation, the control unit 70 operates the needle drive 310 to move the needle tip 330 towards the target position 530 (on the upper surface 420). The position where the needle tip 330 actually touches on the upper surface 420 represents the actual position 610. The camera 320 detects the actual position 610, and the control unit 70 can then determine the deviation 600 of the actual position 610 from the target position 530. The control unit 70 can then calibrate, adjust or otherwise correct the positioning of the needle drive 310 or update the coordinate system the needle drive relies on, for instance by adding or subtracting the determined deviation to the coordinates to which the needle drive is moving the needle, so that the needle tip 330 will actually hit the determined target position 530. This may also be done in an iterated way. For the sake of better illustration, this scheme for correcting an offset between needle 215 and the determined target position 530 is also depicted separately in the lower part of FIG. 6.

1. A fluid handling unit configured for handling a fluid contained or to be contained in a receptacle bearing a marking, wherein the receptacle has a body for containing the fluid and an opening for reaching into the receptacle, and the marking is positioned on the receptacle in a spatially defined relationship to the opening into the receptacle, the fluid handling unit comprising:
a needle having an elongated shape with an open end and being configured for at least one of: aspirating the fluid from the receptacle; and dispensing the fluid into the receptacle;
a needle drive configured for positioning the needle with respect to the receptacle;
a detection unit configured for detecting the marking of the receptacle;
a control unit configured for analyzing the detected marking for determining at least one feature being part of the marking or the marking itself, determining a target position based on the detected at least one feature, wherein the target position is selected to be in spatial relationship to the center point of the opening, and operating the needle drive to position the open end of the needle relative to the determined target position.

2. The fluid handling unit of claim 1, wherein
the control unit is configured for correcting a deviation of an actual position from the determined target position of the open end of the needle, preferably by determining the deviation by using at least one of: an image recognition, an optical measurement, a capacitive measurement, and an inductive measurement, and preferably operating the needle drive to correct for the determined deviation.

3. The fluid handling unit of claim 1, wherein:
the at least one feature has a defined spatial relationship to the opening and preferably to a center point of the opening.

4. The fluid handling unit of claim 1, wherein:
the target position is selected to be the center point of the opening.

5. The fluid handling unit of claim 1, comprising at least one of:
the receptacle comprises at least one of: a container; a vial; a vessel; a tube; and a microtiter plate;
the receptacle comprises a plurality of individual wells each for receiving and storing a fluid;
the needle drive comprises at least one of: a linear stage; an xyz-robot; a robot arm; and a manipulator;
the needle drive is configured for immersing the needle into the receptacle.

6. The fluid handling unit of claim 1, comprising at least one of:
the marking comprises at least one of: a fiducial; a fiducial mark; a barcode; a 2D barcode; an Aztec code; and a machine-readable label or marking;
the marking is located on a surface of the receptacle;
the marking is located on an upper surface of the receptacle;
the marking is located on at least one of: a cap; a lid; a flap; a coverage; a foil; and a seal;
the marking is located on a lower surface of the receptacle;
the marking is located on a lateral surface of the receptacle;
the marking is provided as at least one of: a label; a sticker; and a tag;
the marking is applied by at least one of: printing; stamping; and laser marking
the marking contains at least one material selected from the group consisting of: an ink; a dye; a fluorescent dye; a dielectric material; a metal; a magnetic material; a polymer; a polarizable material; a molten polymer printing; and a material of different color than the surface of the receptacle;
the marking is part of the receptacle;
the marking is part of at least one selected from the group consisting of: a cap; a lid; a flap; a coverage; a foil; and a seal;
the marking comprises an RFID antenna;
the marking is provided by an indentation into and/or elevation on the receptacle.

7. The fluid handling unit of claim 1, comprising at least one of:
the detection unit comprises at least one of: an optical detection unit; a fluorescence detection unit; a phosphorescence detection unit; a magnetic detection unit; and a microwave detection unit;
the detection unit is configured for detecting the marking by providing at least one of: an image recognition; fluorescence imaging; reading dielectric barcodes; and reading magnetic structures;
the detection unit is configured for detecting the marking of the receptacle when the receptacle is located in a dedicated detection area of the fluid handling unit where the detection unit is capable of detecting the receptacle;
the at least one feature to be determined by the control unit is at least one of: a point; a middle point; one or more edges of a geometric object; a geometrical shape; a circle; a square; a rectangle; and a triangle.

8. The fluid handling unit of claim 1, comprising at least one of:
the control unit is configured for operating the needle drive to position the open end of the needle relative to the determined target position above the receptacle, and for moving the needle towards the marking in order to contact the determined target position with the open end of the needle;
the control unit is configured for operating the needle drive to position the open end of the needle into the receptacle for aspirating and/or dispensing the fluid.

9. The fluid handling unit of claim 1, wherein the fluid handling unit is configured for handling a fluid in a chromatography system comprising a mobile phase drive and a separation unit, wherein the mobile phase drive is configured for driving a mobile phase through the separation unit, and the separation unit is configured for chromatographically separating compounds of a sample fluid in the mobile phase, wherein the fluid is contained or to be contained in a receptacle bearing a marking, and the fluid is at least one of: the sample fluid to be injected into the mobile phase and separated compounds of the sample fluid.

10. A chromatography system, comprising:
a mobile phase drive;
a separation unit, wherein the mobile phase drive is configured for driving a mobile phase through the separation unit, and the separation unit is configured for chromatographically separating compounds of a sample fluid in the mobile phase; and
the fluid handling unit of claim 1, wherein the fluid handling unit is configured for handling a fluid contained or to be contained in a receptacle bearing a marking, and the fluid is at least one of: the sample fluid to be injected into the mobile phase; and separated compounds of the sample fluid.

11. The chromatography system of claim 10, wherein the receptacle comprises a marking configured to be for determining at least one feature being part of the marking or the marking itself for determining a target position based on the detected at least one marking, in order to operate a needle drive to position an open end of a needle relative to the determined target position.

12. A method for positioning a needle with respect to a receptacle for aspirating a fluid contained in the receptacle and/or dispensing a fluid into the receptacle, wherein the receptacle bears a marking, the receptacle has a body for containing the fluid and an opening for reaching into the receptacle, and the marking is positioned on the receptacle in a spatially defined relationship to the opening into the receptacle, the method comprising:
detecting the marking of the receptacle;
analysing the detected marking for determining at least one feature being part of the marking or the marking itself, determining a target position based on the detected at least one feature, wherein the target position is selected to be in spatial relationship to the center point of the opening, and
positioning the needle relative to the determined target position.

13. The method according to claim 12, further comprising at least one of:
correcting a deviation of an actual position from the determined target position of an open end of the needle;
detecting the marking by providing at least one of: an image recognition; reading dielectric barcodes; and reading magnetic structures;
detecting the marking of the receptacle when the receptacle is located in a dedicated detection area of the fluid handling unit where the detection unit is capable of detecting the receptacle.

14. The method of claim 12, further comprising at least one of:
positioning an open end of the needle relative to the determined target position above the receptacle;
moving the needle towards the marking in order to contact the determined target position with an open end of the needle;
positioning an open end of the needle into the receptacle for aspirating and/or dispensing the fluid.

15. A non-transitory computer-readable medium with instructions stored thereon, that when executed by a processor, control the steps of the method of claim 12.

16. The method of claim 12, comprising correcting a deviation of an actual position from the determined target position of an open end of the needle, by determining the deviation by using at least one of: an image recognition; a capacitive measurement; and an inductive measurement.
